(19) United States
(12) Patent Application Publication
(10) Pub. No.: US 2018/0338254 A1
(43) Pub. Date: Nov. 22, 2018

(54) BEAM TRACKING METHOD IN MULTI-CELL GROUP OF MILLIMETER WAVE COMMUNICATION SYSTEM AND RELATED APPARATUSES USING THE SAME

(71) Applicant: Industrial Technology Research Institute, Hsinchu (TW)

(72) Inventors: Chung-Lien Ho, Taoyuan City (TW); Ren-Jr Chen, Hsinchu City (TW); Zanyu Chen, Taoyuan City (TW); Wen-Chiang Chen, Hsinchu City (TW)

(73) Assignee: Industrial Technology Research Institute, Hsinchu (TW)

(21) Appl. No.: 15/684,952

(22) Filed: Aug. 24, 2017

Related U.S. Application Data
(60) Provisional application No. 62/509,203, filed on May 22, 2017.

(51) Int. Cl. H04W 24/10

(52) U.S. Cl. CPC H04W 24/10

(57) ABSTRACT

An aspect of the disclosure includes a beam tracking method used by a user equipment, the method would include: receiving, within a first time period, a first plurality of reference signal sequences including a first reference signal sequence associated with a first cell beam and a second reference signal sequence associated with a second cell beam; measure a beam quality which include a first measurement of a first cell beam and a second measurement of a second cell beam; generating, based on the beam quality, a measurement report; and transmitting the measurement report.

### CROSS-REFERENCE TO RELATED APPLICATION

This application claims the priority benefit of U.S. provisional application Ser. No. 62/509,203, filed on May 22, 2017. The entirety of the above-mentioned patent application is hereby incorporated by reference herein and made a part of this specification.

### TECHNICAL FIELD

The disclosure is directed to a beam tracking method in a multi-cell group of a millimeter wave communication system and related apparatuses using the same method.

### BACKGROUND

As a wireless communication system in the next generation will require better performance, certain aspects of the next generation communication system will be overhauled. In particular, since next the generation communication system will transmit in a higher carrier frequency, the propagation of the electromagnetic wave at a higher frequency will experience a greater path loss. For example, the attenuation of electromagnetic waves around the millimeter wave (mmWave) frequency range would be significantly higher than the attenuation around the micro wave frequency range, and thus beamforming could be required to transmit in the mmWave frequency range.

FIG. 1 illustrates examples of radiation patterns of different transmission wavelengths. In general, a communication system operating in the microwave band which has wavelengths in the centimeter range (i.e. cmWave) tends to have a small number of antennas. The radiation pattern of a single microwave frequency antenna 101 tending to be long distance, has a broad field-of-view (FoV) coverage, and is typical for a 3G/4G communication systems that use the micro-wave band with small number of base station (BS) antennas to achieve a higher receive SNR quality. However, low data rate due to small BW exists in such the systems. To increase the data rate by using a large BW, mmWave band is considered in the future communication system (e.g. 5G systems). The radiation pattern of a single mmWave single frequency antenna 102 covers a shorter distance; however, the mmWave radiation pattern with a related narrower FoV coverage 103 as the result of mmWave beamforming could be extended by using an mmWave antenna array for beamforming under the same transmitted power. To achieve the broad FoV coverage as 3G/4G communication systems, a number of beams 104 may be used at BS, and a beam sweep mechanism for the BS beams may be considered. In particular, each of the BS beams 104 may have a different beam sequence ID (i.e. q^{th} beam has beam sequence ID q) for the beam sweep. In general, an mmWave communication system that uses a small sized antenna array tends to have a shorter distance and a broad coverage; whereas an mmWave communication system that uses a larger sized antenna array tend to have a longer distance and a narrower coverage.

The transmission framework of mmWave wireless communication systems could be classified into two categories based on the radio access interface. A first category is multiple radio access technology (multi-RAT) and a second category is single radio access technology (single-RAT). FIG. 2 illustrates an example of a 5G multi-RAT communication system of the first category and a 5G single-RAT communication system of the second category. The multi-RAT system has at least two RATs such as a LTE system and an mmWave system which have been phrased as the LTE+mmWave integrated system which would co-exist simultaneously for communications. For example, control signaling could be transmitted by using the conventional LTE communication frequency whereas the user data could be transmitted by using mmWave communication frequency. In such case, the carrier aggregation (CA) scheme could be utilized. The user data could be transmitted over the mmWave band by using, for example, a secondary component carrier (SCC), but control signals could be transmitted over the microwave (i.e. cmWave) frequency by using a primary component carrier (PCC). Network entry could be performed via the cmWave by using a PCC since a successful detection rate for control signaling could be operated in large coverage, high mobility and low SNR scenarios. On the other hand, the single-RAT communication system of the second category would use only one radio access technology for communication applications by using the mmWave band to transmit both user data and control signals. Network entry would be performed via a carrier in the mmWave band. Thus, a successful detection rate for control signaling may need to be operated in small coverage, low mobility and high SNR scenarios. Thus beamforming technique may be used. It is worth noting that, for the exemplary embodiments of the disclosure, only the single mmWave RAT of the second category would be considered.

For a standalone next generation (i.e. 5G) communication system as described in the second category of FIG. 2, there could be several design challenges. For instance, referring to FIG. 3, a user equipment (UE) that supports a next generation 5G standard of the second category would be configured to receive a directional beam 301 from a base station (BS) that also supports a next generation 5G standard of the second category. However, under some circumstances, the directional beam 302 could be blocked by an obstacle such as a concrete building. Moreover since a 5G BS has a specific zone of coverage 303, the mechanism of handover from one cell beam to another cell beam while the 5G UE is at a boundary 304 between zones of coverage would need to be determined.

To tackle issues such as an issue related to mobility, a UE-centric non-cell system could be proposed. FIG. 4 shows a comparison between a cell centric cellular system and a UE centric non-cell system. A method of meeting requirements of an ultra-high traffic volume density in a 5G communication system could be to utilize a design based on an ultra-dense network (UDN). In legacy system such as 3G and LTE networks, cellular communication is a cell-centric cellular system. However, for a 5G communication system, a user equipment (UE) would be deployed in a UE-centric non-cell radio access system. The abstraction of UE radio access along with virtualized cell concept may enable slicing of a radio access network (RAN) by decoupling a UE from a physical cell against the mobility related issues, by decoupling a physical topology with services, and by simplifying heterogeneous nodes deployments against the blockage related issues.

In a 5G communication system, a cell size would likely be small because of high carrier frequencies. Handover due to UE mobility could be handled effectively by a UDN. However, ultra-high traffic loads and high density experienced by the 5G network may force a fronthaul network to be decoupled from physical entities to result in a split between the control plane and the data plane (C/U split) in the future. FIG. 5 illustrates a split between control plane and user plane in a 5G communication system by utilizing the concept of a virtual layer. This means that the control plane (C-plane) would be deployed on the virtual layer only and so data plane (U-plane) would be deployed on the real layer. Thus, the physical layer data could be decoded in real layer and forwarded via the fronthaul network to the virtual layer. The decoded data would subsequently be transformed to a MAC message to communicate with the core network. Under this scheme, cell re-selections or handovers for UEs may no longer required within the same virtual layer. Such concept would be consistent with the implementation of the UE-centric virtual cell which could be equivalent to the virtual layer of FIG. 5.

### SUMMARY OF THE DISCLOSURE

Accordingly, the disclosure is directed to a beam tracking method in a multi-cell group of a millimeter wave communication system and related apparatuses using the same method.

In one of the exemplary embodiments, the disclosure is directed to a beam tracking method used by a user equipment in a multi-cell group of a millimeter wave communication system, and the method would include not limited to: receiving, within a first time period, a first plurality of reference signal sequences including a first reference signal sequence associated with a first cell beam and a second reference signal sequence associated with a second cell beam; measuring a beam quality which includes a first measurement of a first cell beam and a second measurement of a second cell beam; generating, based on the beam quality, a measurement report; and transmitting the measurement report.

In one of the exemplary embodiments, the disclosure is directed to a beam track method used by a base station in a multi-cell group of a millimeter wave communication system, and the method would include no limited to: transmitting, within a first time period, a first reference signal sequence generated according to a first time-division multiplexing (TDM) configuration of a plurality of TDM configurations, wherein the first TDM configuration within a time period is unique to each cell within the multi-cell group; receiving, from a preferred cell beam, a measurement report in response to transmitting the first reference signal sequence; performing a cell quality measurement based on an UL signal received from the preferred cell beam in response to receiving the measurement report; and transmitting the cell quality measurement to controller.

In one of the exemplary embodiments, the disclosure is directed to a user equipment which would include not limited to: a transmitter; a receiver; and a processor coupled to the transmitter and the receiver and configured to: receive, via the receiver within a first time period, a first plurality of reference signal sequences including a first reference signal sequence associated with a first cell beam and a second reference signal sequence associated with a second cell beam; measure a beam quality which includes a first measurement of a first cell beam and a second measurement of a second cell beam; generating, based on the beam quality, a measurement report; and transmit, via the transmitter, the measurement report.

In one of the exemplary embodiments, the disclosure is directed to a base station which would include not limited to: a transmitter; a receiver; and a processor coupled to the transmitter and the receiver and configured to: transmit, via the transmitter within a first time period, a first reference signal sequence generated according to a first time-division multiplexing (TDM) configuration of a plurality of TDM configurations, wherein the first TDM configuration within a time period is unique to each cell within the multi-cell group; receive, via the receiver from a preferred cell beam, a measurement report in response to transmitting the first reference signal sequence; perform a cell quality measurement based on an UL signal received from the preferred cell beam in response to receiving the measurement report; and transmit, via the transmitter, the cell quality measurement to controller.

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates characteristics of an mmWave communication system.

FIG. 2 illustrates a 5G new radio (NR) transmission framework.

FIG. 3 illustrates issues related to a 5G NR standalone communication system.

FIG. 4 compares between a cell centric cellular system and a UE centric non-cell system.

FIG. 5 illustrates a split between control plane and user plane in a 5G communication system by utilizing the concept of a virtual layer.

FIG. 6 compares concepts between joint tracking and individual tracking in accordance with one of the exemplary embodiments of the disclosure.

FIG. 7 illustrates decisions of preferred beams in accordance with one of the exemplary embodiments of the disclosure.

FIG. 8 compares concepts between non-reusable beam sequence and reusable sequence in accordance with one of the exemplary embodiments of the disclosure.

FIG. 9A illustrates a concept of beam sequence ambiguity for a sequence reuse system in accordance with one of the exemplary embodiments of the disclosure.

FIG. 9B illustrates an example of beam sequence ambiguity with J=Q=8 in accordance with one of the exemplary embodiments of the disclosure.

FIG. 10 illustrates an example of interlaced scan beams in accordance with one of the exemplary embodiments of the disclosure.

FIG. 11 illustrates another example of interlaced scan beams in accordance with one of the exemplary embodiments of the disclosure.

FIG. 12 illustrates configurations of TDM based beam sequence ID mapping in accordance with one of the exemplary embodiments of the disclosure.

FIG. 13 illustrates an example of beam sequence for boresight alignment with J=Q=8 in accordance with one of the exemplary embodiments of the disclosure.

FIG. 14 illustrates an example of beam sequence for non-boresight alignment with J=Q=8 in accordance with one of the exemplary embodiments of the disclosure.

FIG. 15 illustrates an example of beam sequence for different beam sweep direction with J=Q=8 in accordance with one of the exemplary embodiments of the disclosure.

FIG. 16 illustrates another example of beam sequence for boresight non-alignment and different beam sweep direction with J=Q=8 in accordance with one of the exemplary embodiments of the disclosure.

FIG. 17 illustrates an example of beam sequence for boresight alignment with J=24≥Q=8 in accordance with one of the exemplary embodiments of the disclosure.

FIG. 18 illustrates transmitting multiple BQM-RSs from among cells in accordance with one of the exemplary embodiments of the disclosure.

FIG. 19 illustrates BTS based BQM-RS allocations in accordance with one of the exemplary embodiments of the disclosure.

FIG. 20 illustrates an example of BSS based BQM-RS allocations in accordance with one of the exemplary embodiments of the disclosure.

FIG. 21 illustrates an example of distributed BTS based BQM-RS allocations in accordance with one of the exemplary embodiments of the disclosure.

FIG. 22 illustrates an example of beam tracking in accordance with one of the exemplary embodiments of the disclosure.

FIG. 23 illustrates a SNR table in accordance with one of the exemplary embodiments of the disclosure.

FIG. 24 illustrates SNR measurement reporting in accordance with one of the exemplary embodiments of the disclosure.

FIG. 25 illustrates SNR reporting from a UE to BSs in accordance with one of the exemplary embodiments of the disclosure.

FIG. 26 illustrates RAP transmission by UE in accordance with one of the exemplary embodiments of the disclosure.

FIG. 27A & FIG. 27B illustrates diversity for non-contention based RAP in accordance with one of the exemplary embodiments of the disclosure.

FIG. 28 illustrates an application of the SNR table in accordance with one of the exemplary embodiments of the disclosure.

FIG. 29A is a functional block diagram of a UE in accordance with one of the exemplary embodiments of the disclosure.

FIG. 29B is a functional block diagram of a BS in accordance with one of the exemplary embodiments of the disclosure.

FIG. 30A illustrates steps of a beams tracking method used in a multi-cell group of a millimeter wave communication system from the perspective of a UE in accordance with one of the exemplary embodiments of the disclosure.

FIG. 30B illustrates steps of a beams tracking method used in a multi-cell group of a millimeter wave communication system from the perspective of a BS in accordance with one of the exemplary embodiments of the disclosure.

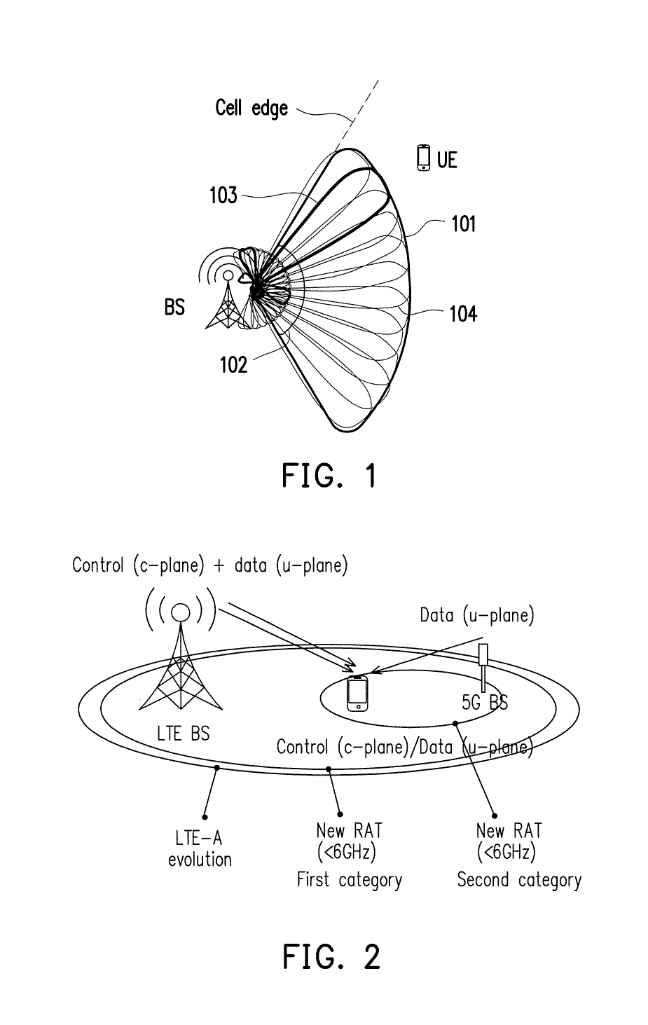

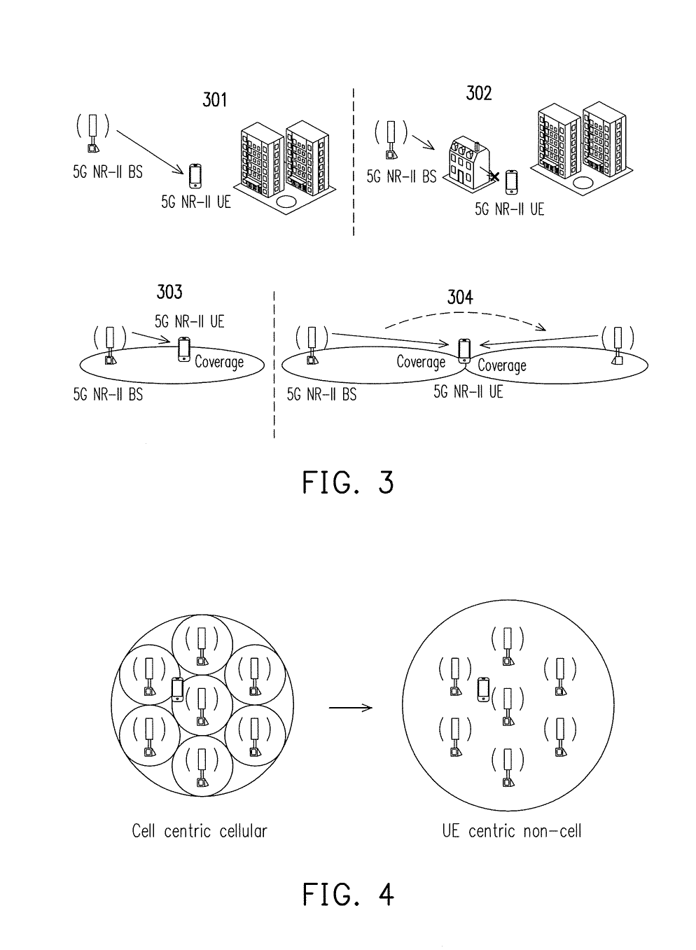

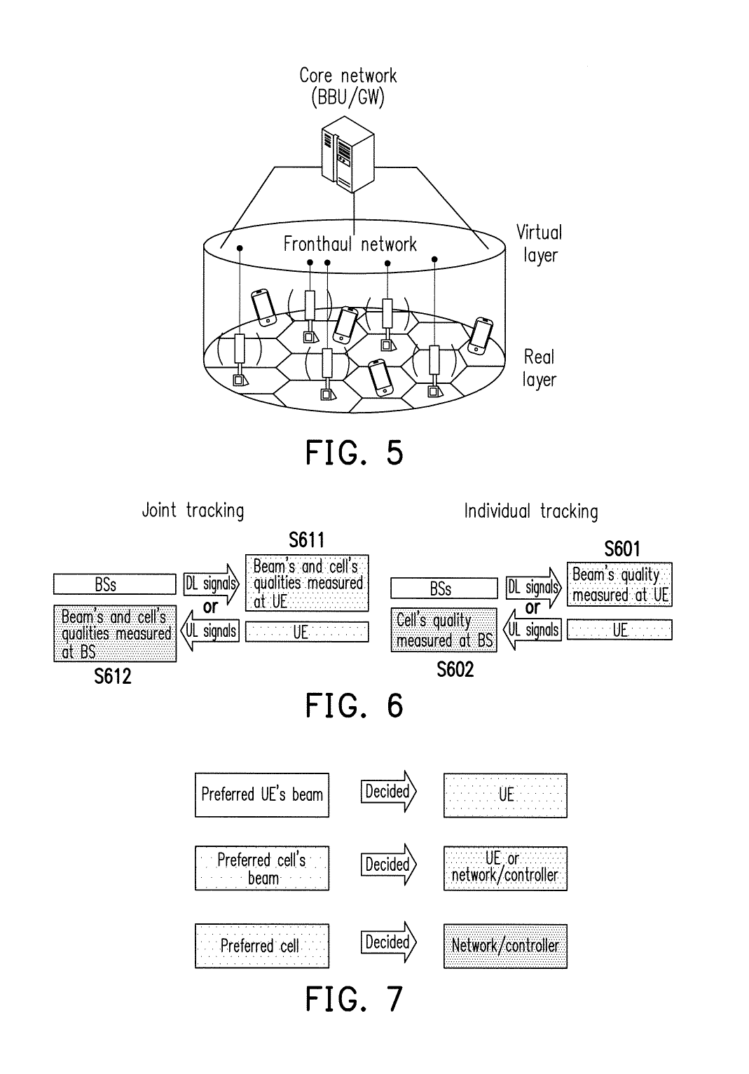

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The disclosure is directed to a beam tracking method and related apparatuses in a multi-cell group of a millimeter wave communication system, and in particular the disclosure provides a method of multi-beam and multi-cell tracking (MBMCT) used by apparatuses in a millimeter (mmWave) communication system. In this disclosure, each UE may measure or detect the qualities of cell scan beams based on downlink (DL) signals; whereas BSs may measure or detect the qualities of cells based on uplink (UL) signals reported by UE from preferred cell scan beams. Thus, the cell scan beam quality and cell quality could be separately measured or tracked. An individual cell scan beam of a base station may carry a (reference signal) sequence and each sequence would correspond to an identifier (ID). Since a same set of sequences generated by a base station could also be used by another base station within the same mmWave system, a single or a same set of multiple beam sequence IDs (or sequences) could be re-used by another one or more cells within the mmWave system.

Further, a base station may (repeatedly) transmit a set of beam quality measurement reference signals (BQM-RSs) with each BQM-RS having a different beam sequence ID from the rest of the BQM-RSs transmitted by the base station. The beam sequence IDs which could be derived from BQM-RSs which could be carried by cells' scan beams and could be interlaced. The BQM-RSs carried by the cell scan beams could transmitted simultaneously from different cells with one BQM-RS per cell per transmission. Also, each BQM-RS would be associated with a different beam sequence ID. For instance, a first reference signal sequence could be derived from a BQM-RS received from the first cell beam, and the second reference signal sequence could be derived from a second BQM-RS received from the second cell beam. The first beam sequence ID could be derived from the first reference signal sequence, and the second beam sequence ID could be derived from the second reference signal sequence.

Beam quality measurement statistics not limited to signal-to-noise ratio (SNR) could be measured by a UE based on BQM-RSs for tracking cell's beams and UE's beams. The beam quality measurement and/or the preferred beam sequence ID associated with a particular cell scan beam could be reported by the UE via control/shared channels (CCHs/SCHs) within uplink (UL) beamforming (BF) header(s) at a preferred reporting time which corresponds to the reporting time used by the cell's receive scan beam having the maximum measurement SNR in a downlink (DL) transmission. A random access preamble (RAP) with a unique sequence ID used by UE should be known to some BSs (and/or network) near the UE and could be transmitted on random access (RA) channel (RACH) of UL BF header at the above preferred UL time. The cell's SNR-like quality on CCH RS/SCH RS/RACH could be measured at the BSs and consequently the best cell could be decided by a controller based on the cell's SNR measurements.

First a comparison between joint tracking and individual tracking would be described. A comparison is shown in FIG. 6 which describes that the tracking of the multiple beams and multiple cells could be either based on a joint tracking mechanism or individual tracking mechanism. For joint tracking, in step S611 the beam's and the cell's qualities would be measured by a UE based on a DL signal provided by a BS, but also in step S612 the beam's and the cell's qualities would also be measured by a BS based on a UL signal provided by the UE. This means that the beam's quality and cell's quality would jointly be measured or tracked by the UE and/or the BS. For individual tracking on the other hand, in step S601 a cell scan beam quality transmitted from a BS could be measured or tracked by the UE by using a DL signal provided by a BS, and in step S602 the cell's quality could be measured or tracked by a UL signal provided by a UE. It is worth noting that the disclosure mostly pertains to but necessarily limited by the individual tracking mechanism as above described. Advantages of individual tracking relative to joint tracking would include lesser computational complexity, shorter measurement period, and lower RS/signaling overhead. Also note that the disclosure is not limited by the necessity to possess all the above described advantages.

Under the individual tracking mechanism, as shown in FIG. 7, the decision on the preferred UE's beam could be decided by UE itself, and such decision could be transparent to BSs or a controller. The decision on the preferred cell's beam could be decided by either a UE or by a controller. The preferred cell could be decided by a controller. The term “controller” in this disclosure would refer to a concept similar to a radio network controller (RNC) which typically connects to and controls multiple base stations.

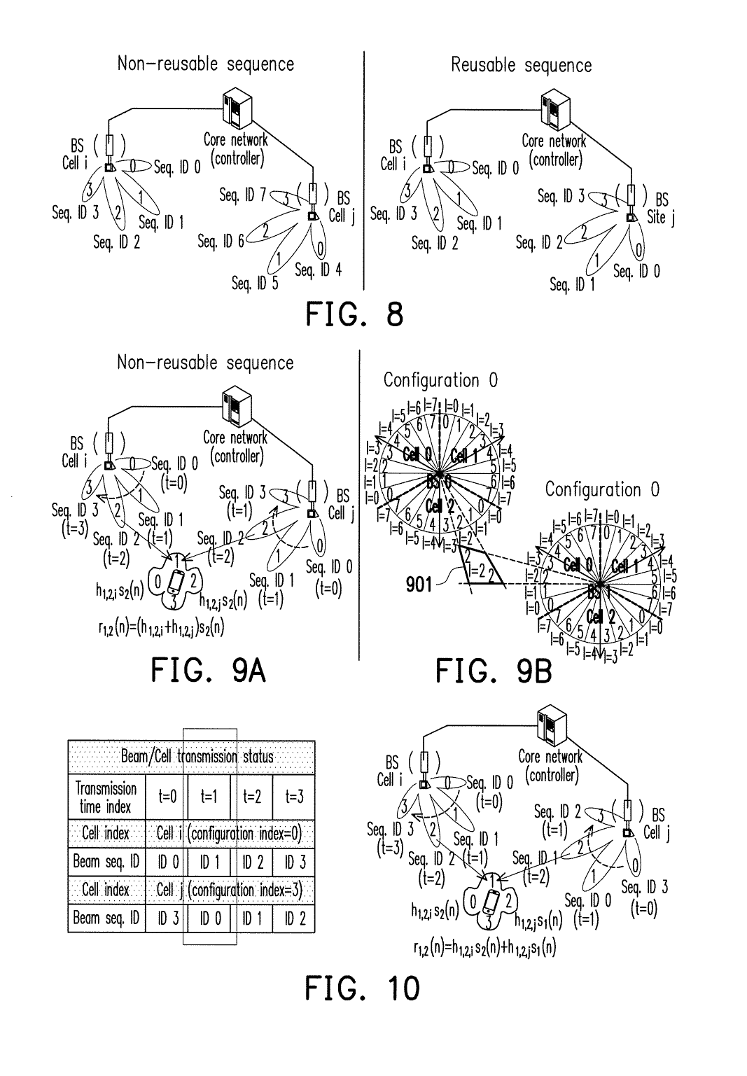

FIG. 8 illustrates a comparison between non-reusable beam sequence and reusable sequence. The beam sequence identifiers (IDs) for beam tacking could either be non-reused or reused for the multiple cells as shown in FIG. 8. It is worth noting that, a beam sequence ID as described by this disclosure is not beam ID or beam index which would typically be used to index each individual beam of a base station. For a sequence non-reusable system, multiple or different sets of Q beam sequence IDs or sequences would be used for multiple cells. Assuming that there are N_{d} sets, it may then require QN_{d} measurements and detections. The best performance could be obtained but it would induce slower measurement/report and higher RS/signaling overhead. For sequence reusable system, a single (the same) set of J (Q≤J≤QN_{d}) beam sequence IDs could be reused for multiple cells. By using J measurements and detections, measurement and report could be faster, the need of RS/signaling overhead could be lowered by sacrificing some (a very slight) performance degradation.

FIG. 9A illustrates a concept of beam sequence ambiguity for a sequence reuse system in accordance with one of the exemplary embodiments of the disclosure. One potential issue associated with the sequence reusable system is that if two or more beam sequences having the same beam sequence ID from different cells are received by a UE at the same time as illustrated in FIG. 9A, there could be a beam sequence ID ambiguity. The beam sequence ID ambiguity is caused by a non-coherent combination into the received signal r_{p,q}(n) based on receptions from the two cells (i.e. (h_{1,2,i}+h_{1,2,j})s₂(n), where h_{p,q,i} is the channel gain from the qth beam of the ith cell to the pth UE beam and s_{q}(n) is a Zadoff-Chu (ZC) sequence with beam sequence ID (i.e. root) q. The beam sequence ID ambiguity would then result in an inaccurate measurement on the beam sequence ID.

FIG. 9B illustrates an example of beam sequence ambiguity with J=Q=8 in accordance with one of the exemplary embodiments of the disclosure. It can be seen from FIG. 9B that both BS 0 and BS 1 have the same beam sequence configuration, for example, configuration 0 which has 8 beam sequence IDs. Any UEs located within the zone 901 may experience the beam sequence ID ambiguity as the result of receiving from BS 0 a first cell scan beam having beam sequence ID=2 as well as receiving from BS 1 a second cell scan beam also having beam sequence ID=2.

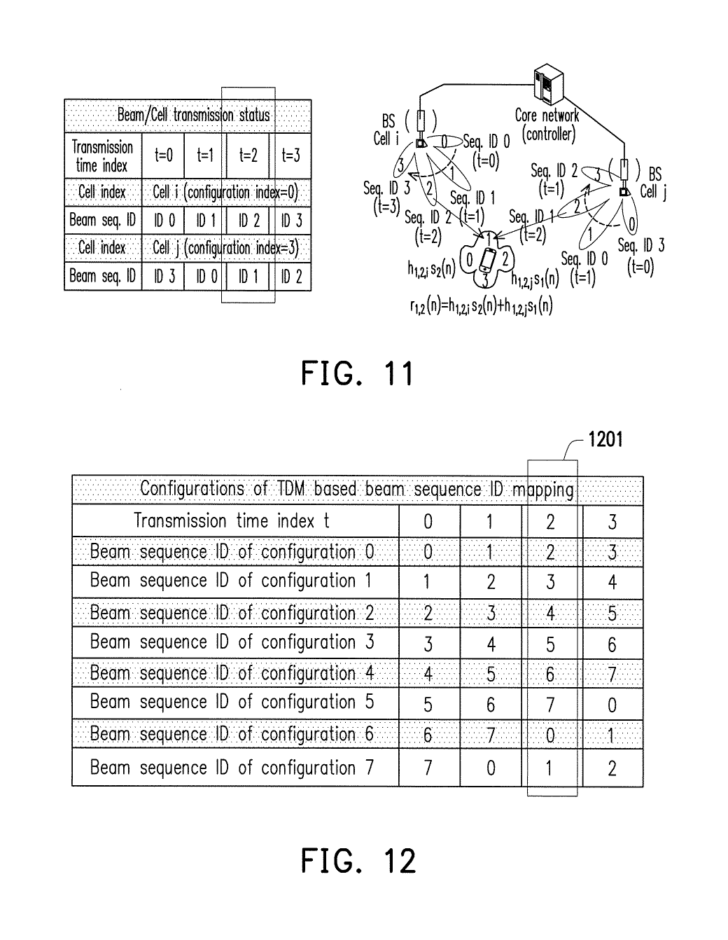

In order to avoid beam sequence ID ambiguity, an interlaced beam transmitting structure could be used. FIG. 10 illustrates an example of interlaced scan beams in accordance with one of the exemplary embodiments of the disclosure. In order to effectively measure the cells' beam quality, a set of beam quality measurement reference signals (BQM-RS) would be used in the DL beamforming (BF) header. By receiving a BQM-RS carried within a DL signal from a BS, a UE may perform beam quality measurement based on the BQM-RS. Thus, in order to avoid the beam sequence ID ambiguity problem, the beam sequence IDs used for BQM-RSs carried by cells' beams should be interlaced to avoid beam sequence ID ambiguity problem. For this exemplary embodiment, multiple BQM-RSs transmitted from multiple cells could be expected. From the example of FIG. 10, it can be seen that the BQM-RSs transmitted simultaneously from at least two different cells. A first BQM-RS which has a first beam sequence ID having a specific ZC sequence s_{q}(n) per cell per transmission and is carried by a first cell scan beam from cell i would be received by a UE for beam selection or beam tracking. A second BQM-RS which has a second beam sequence ID having another ZC sequence and is carried by a second cell scan beam from cell j could also be received by the UE for beam selection or beam tracking. In this way it can be seen from FIG. 10 that, for example, at time index t=1, the beam sequence ID of the cell scan beam from cell i is 1, and the beam sequence ID of the cell scan beam from cell j is 0. Similarly, as shown in FIG. 11, at time index t=2, the beam sequence ID of the cell scan beam from cell i is 2, and the beam sequence ID of the cell scan beam from cell j is 1. Therefore, beam sequence ID ambiguity problem could be avoided.

The UE may perform a plurality of beam quality measurements in response to receiving BQM-RSs. For instance, in response to obtaining the first BQM-RS, the UE may perform a first beam quality measurement of the first cell scan beam. Similarly, in response to obtaining the second BQM-RS, the UE may perform a second beam quality measurement of the second cell scan beam. The UE may also receive a third BQM-RS, a fourth BQM-RS, and so forth and performs beam quality measurements accordingly. The UE may determine, from the plurality of beam quality measurements, the preferred beam sequence ID in terms of having the highest signal to noise ratio (SNR) and subsequently select a preferred UE beam to transmit (all of) the plurality of beam quality measurements and/or the preferred beam sequence ID to a preferred cell scan beam at the time which corresponds to the cell scan beam having the highest beam quality of the cell beams measurement such as the highest SNR as measured by the UE. In response to receiving the reporting by UE from preferred cell scan beam, a cell may perform a cell quality measurement based on the UE's reporting and transmit the result of the cell quality measurement to a controller. Similarly, another cell may also perform a cell quality measurement based on the UE's reporting and transmit the result of the cell quality measurement to the controller. The controller may subsequently determine at least one preferred cell based on the received cell quality measurements to serve the UE.

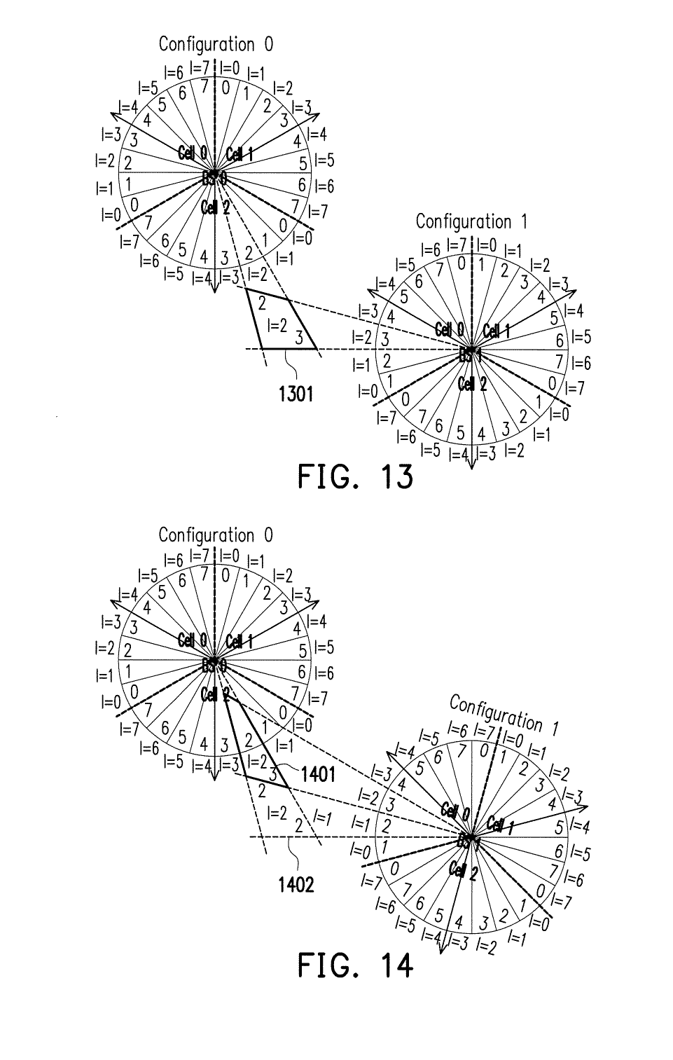

The beam sequence ID ambiguity issue could be avoided by configuring each cell to generate and subsequently transmit a reference signal sequence based on a time index and a configuration of a plurality of configurations. FIG. 12 illustrates configurations of TDM based beam sequence ID mapping in accordance with one of the exemplary embodiments of the disclosure. The information of FIG. 12 could be stored as a lookup table within any BS or UEs and such table could be referred to as TDM based beam sequence ID configuration table. In the example of FIG. 12, the identification capability is assumed to be eight and the number of cell's beams is assumed to be four and thus J=8 and Q=4; however, the disclosure is not limited to these specific numbers. The configuration within a time period per cell is unique to the base station within the multi-cell group. For example, at time index t=2 1201, there would be up to eight different configurations and thus eight different sequences detected by a UE to distinguish among eight cells. Thus, within a multi-cell group, since the TDM based beam sequence ID configuration is unique for each cell, no UE would receive two BS scan beams having the same beam sequence IDs from two different cells. The specific TDM based beam sequence ID configuration to be used for each cell could be determined by a controller.

In general, the beam sequence ID N_{ID}^{Seq}(q) could have a specific mapping to the time index t, 0≤t≤Q−1, for each cell, called the TDM based beam sequence ID mapping. For example, if Q beams are used at each of cells for a system with identification capability J, then N_{ID}^{Seq}(q) could be generated as follows:

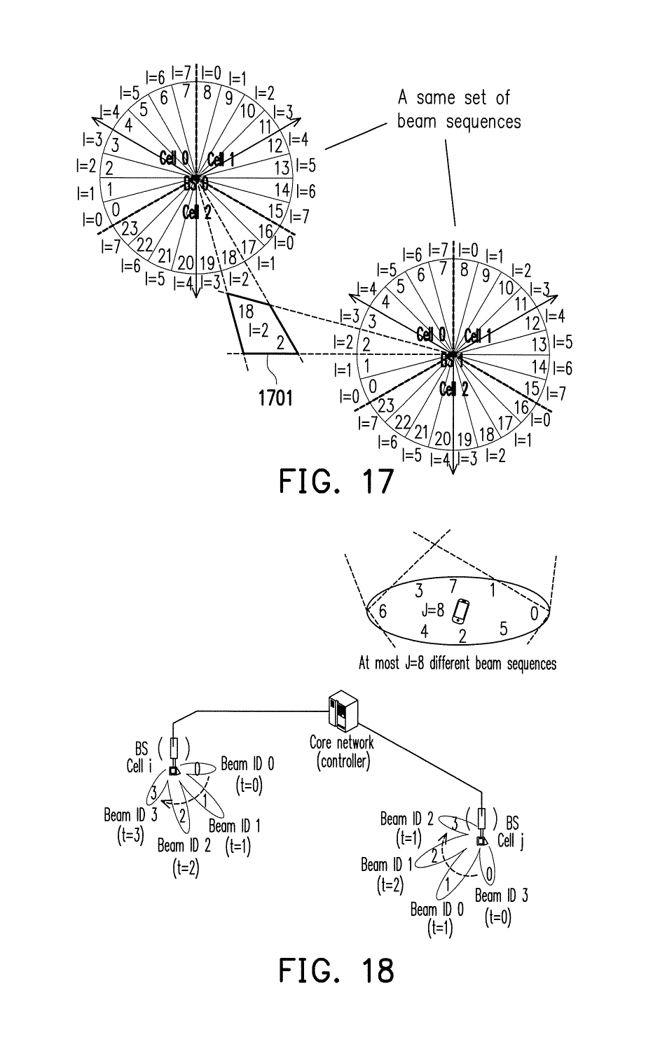

N_{ID}^{Seq}(q)=mod(t+n_{Config},J), 0≤t≤Q−1, 0≤n_{Config}≤J−1 (1)

where n_{Config} is the configuration index of the mapping, which could be semi-persistently scheduled or dynamically scheduled or configured by a controller. At most Q BQM-RSs would be transmitted from multiple cells within a multi-cell group as each of the cell would use a different beam sequence ID per time index, and multiple unique beam sequence IDs could be simultaneously received by a UE to do the MBMCT. Thus, the BQM-RSs transmitted by the cells' scan beams could be the reused among multiple cells within a multi-cell group. FIG. 13˜FIG. 17 provide various examples for avoiding beam sequence ID ambiguity.

FIG. 13 illustrates an example of beam sequence for boresight alignment with J=Q=8 and thus each configuration has 8 time periods per cycle as each time period in a cycle corresponds to one of the time indexes l=0˜7. In this example, BS 0 has been configured with configuration 0 of the TDM based beam sequence ID configuration, BS 1 has been configured with configuration 1, and thus at l=2, a UE within the overlapping region 1301 may receive a first scan beam having a beam sequence ID of 2 from BS 0 and a second scan beam having a beam sequence ID of 3 from BS 1. In this way, there is no beam sequence ID ambiguity for the ID within the overlapping region 1301.

FIG. 14 illustrates an example of beam sequence for non-boresight alignment with J=Q=8. In this example, BS 0 has been configured with configuration 0 of the TDM based beam sequence ID configuration, BS 1 has been configured with configuration 1. At l=2, a UE within the region 1401 may receive a first scan beam having a beam sequence ID of 2 from BS 0 and a second scan beam having a beam sequence ID of 3 from BS 1. In this way, there is no beam sequence ID ambiguity for the UE within the region 1401. As for the region 1402, a UE would receive a first scan beam having a beam sequence ID of 2 from BS 0 and also a second scan beam having a beam sequence ID of 2 from BS 1. However, the beam sequence ID of 2 is received from BS 0 at time index l=2, the beam sequence ID of 2 is received from BS 1 at time index l=1, and thus there is no beam sequence ID ambiguity for the UE within the region 1402.

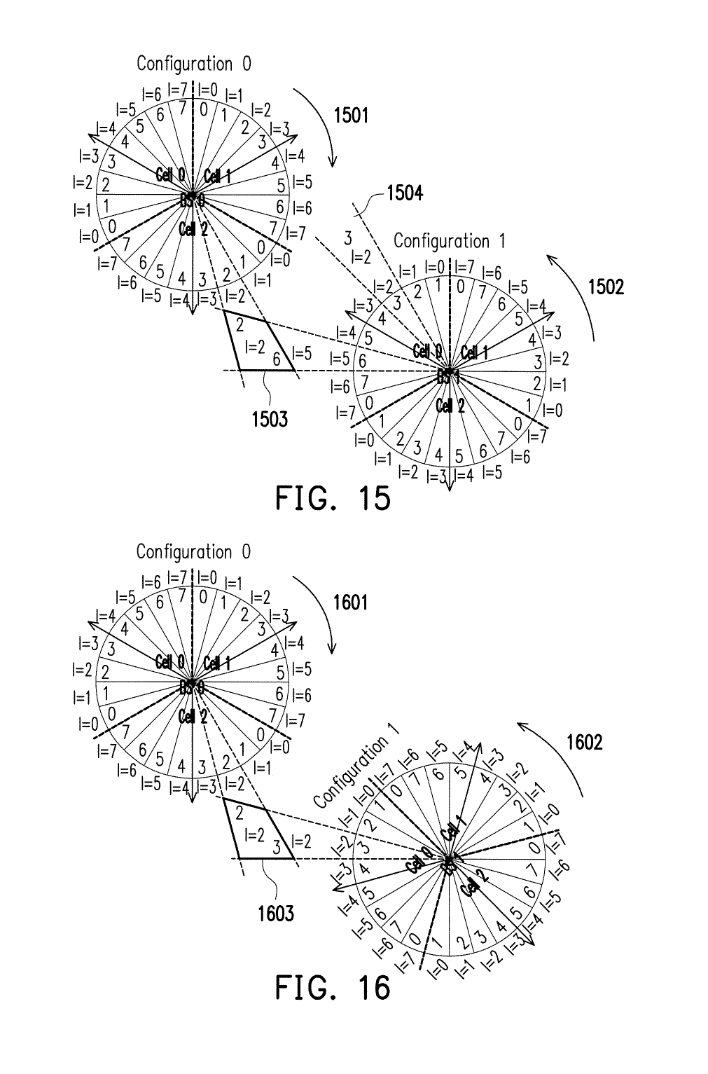

FIG. 15 illustrates an example of beam sequence for different beam sweep direction with J=Q=8. In this example, BS 0 has been configured with configuration 0 of the TDM based beam sequence ID configuration, BS 1 has been configured with configuration 1. The BS 0 may transmit up to 8 scan beams which scan in a clockwise direction 1501, and the BS 1 may transmit up to 8 scan beams which scan in a counter-clockwise direction 1502. Within the region 1503, the first scan beam from BS 0 would correspond to beam sequence ID 2 at l=2 while the second scan beam from BS 1 would correspond to beam sequence ID 6 at l=5, and thus there is no beam sequence ID ambiguity for the UE within the region 1503. Also within region 1504 covered by the scan beam which corresponds to beam sequence ID 3 transmitted at time index l=2 from BS 1, there is also no beam sequence ID ambiguity for any UE within the region 1504 since at time index l=2, there wouldn't be any scan beams coming from BS 0 that corresponds to beam sequence ID of 3 which is the same as the beam sequence ID of the scan beam transmitted from BS 1 also at time index l=2.

FIG. 16 illustrates another example of beam sequence for boresight non-alignment and different beam sweep direction with J=Q=8. In this example, BS 0 has been configured with configuration 0 of the TDM based beam sequence ID configuration and transmits scan beams in a clockwise direction 1601. BS 1 has been configured with configuration 1 and transmits scan beams in a counter-clock wise direction. At l=2, a UE within the region 1603 may receive a first scan beam having a beam sequence ID of 2 from BS 0 and a second scan beam having a beam sequence ID of 3 from BS 1. In this way, there is no beam sequence ID ambiguity for the UE within the region 1603.

The number identification capability, J, may also be much greater than the maximum number of scan beams transmitted per cell. FIG. 17 illustrates an example of beam sequence for boresight alignment with J=24≥Q=8. In this example, BS 0 has a maximum of 24 different beam sequence IDs for 3 cells with Q=8 different beam sequence IDs per cell, and thus each of the Q scan beams per cell would have a unique beam sequence ID. Similarly, BS 1 also has a maximum of 24 different beam sequence IDs for 3 cells with Q=8 different beam sequence IDs per cell, and thus each of the Q scan beams per cell would have a unique beam sequence ID. The set of beam sequence ID used in BS 0 would be identical to the set of beam sequence ID used in BS 1. Also notice that in this example, there would also be no beam sequence ID ambiguity since nowhere would a UE receive two cell scan beams from two different BSs with the same beam sequence ID. For instance, in the region 1701, at time index l=2, a UE would receive a first cell scan beam which corresponds to beam sequence ID of 18 and a second cell scan beam which corresponds to a beam sequence ID of 2. There would be no beam sequence ID ambiguity since the beam sequence IDs of the two cell scan beams from two different BSs are different. This particular embodiment of FIG. 17 may have better performance at the cost of higher RS/signaling overhead and measurement complexity.

The maximum number of cells in a multi-cell group would be determined by the maximum number of identification capability, J. FIG. 18 illustrates an example of transmitting multiple BQM-RSs from among cells in a multi-cell group. Since J=8 in the example of FIG. 18, there would be at most J BQM-RSs transmitted from multiple cells with each cell having a different beam sequence ID per time index. All of these BQM-RSs could be simultaneously received by a UE which would perform the MBMCT mechanism.

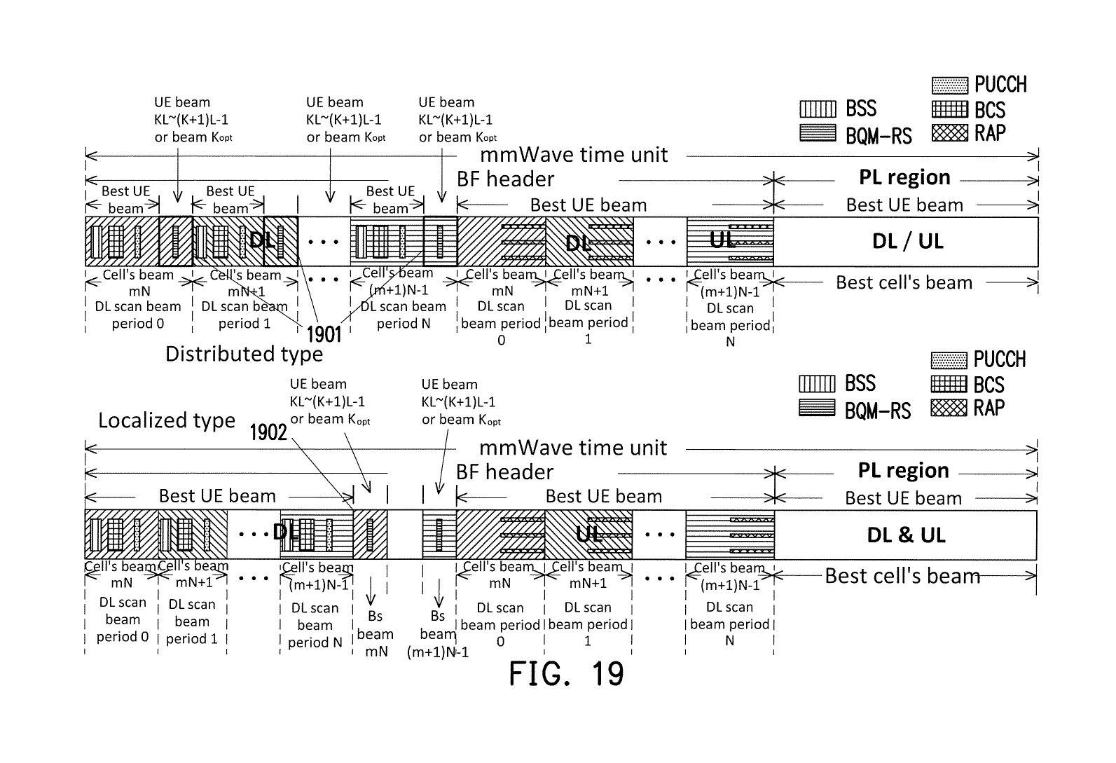

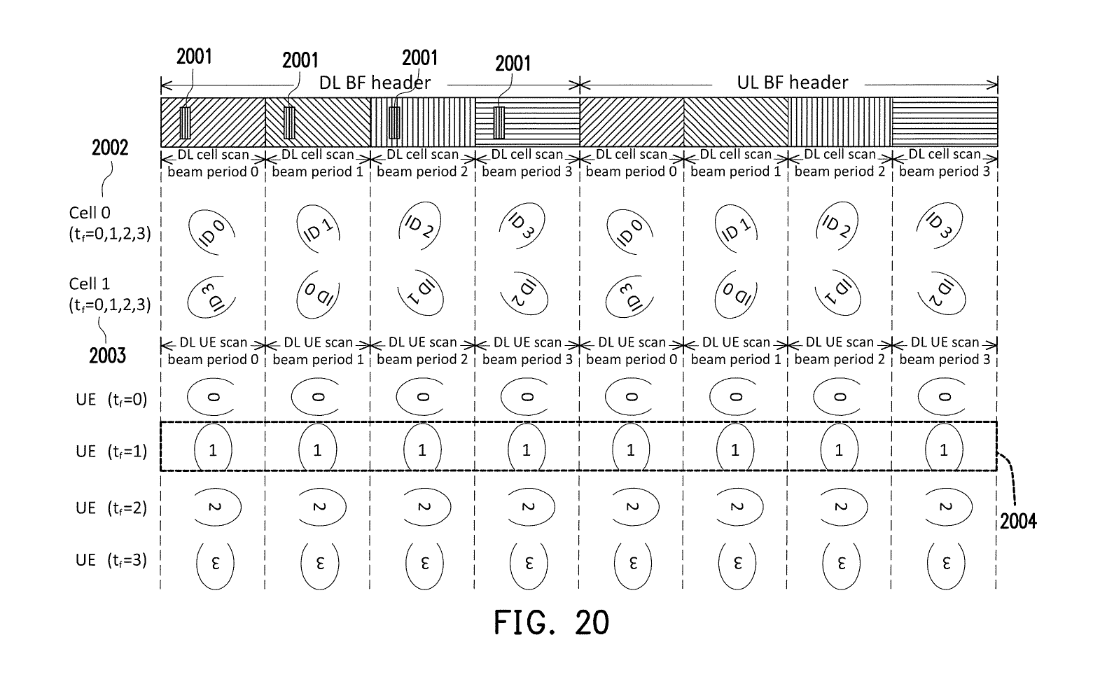

For accomplishing beam detection or tracking as above described, a frame structure which contains the BQM-RSs is shown in FIG. 19 which illustrates beam tracking signal (BTS) based BQM-RS allocations. Alternative to BTS, beam search signal (BSS) may also be used as a substitute for BQM-RS. The use of BSS may result in lower RS overhead, may require longer measurement period/time, and may exhibit slower beam tracking capability which may not be adequate for fast varying channels. The resource allocation of BTS based BQM-RSs could be within a beam quality measurement resource (BQMR) within a DL BF header. The allocations of BQM-RS could be distributed allocation 1901 or localized allocation 1902. It can be seen from FIG. 19 that the BQMRs which contain BQM-RSs of the distributed allocation 1901 type are alternatively located within a DL BF header and are grouped with other signals, and the BQMRs which contain BQM-RSs of the localized allocation 1902 type are located together in DL BF header in a consecutive manner. In other words, BQMR of the distributed allocation 1901 type are not consecutive from one another; and whereas BQMR of localized allocation 1902 type are consecutive from one another.

For the embodiment of FIG. 19, there would be Q scan beams transmitted from a base station at a cell. The Q scan beams could be deterministically defined and sequentially transmitted over M mmWave radio frames, and each BF header of a radio frame would be allocated with N scan beams where N=Q/M. The allocation of the Q beams may repeat every M mmWave radio frames, and thus N=Q/M with indices mN˜(m+1)N−1 could be used in the m^{th} mmWave time unit. For this exemplary embodiment, there would also be P scan beams transmitted from a UE. In each BQMR of a DL BF header of a cell scan beam, the best UE beam with index kₒₚₜ, or L (1≤L≤P) scan UE beams with indices kL˜(k+1)L−1 could be used to receive the BQI-RSs in the k^{th} mmWave time unit, 0≤k≤K−1, where K=MP/L is the UE scan beam beacon period. A UE may measure the signal qualities of cell scan beams based on the received BQM-RS, and the UE may subsequently self-select a preferred UE scan beam to transmit the measured signal qualities to the BSs that correspond to the cell scan beams via the appropriate cell scan beams and time period according to the TDM based beam sequence ID configuration table as previously described.

An example of BSS based BQM-RSs for N_{d}=2, J=Q=4, and P=4 is shown in FIG. 20 to further describe a principle of operation of BQM-RS. N_{d} is the number of cells within a multi-cell group, J is the identification capability or the maximum number of beam sequence IDs used by a BS beam group, Q is the number of cell's beams, and P is the number of UE's beams. The DL BF header of the frame shown in FIG. 20 would include at least four DL scan beam periods, namely, DL scan beam period 0, DL scan beam period 1, DL scan beam period 2, DL scan beam period 3. Each of the four BQM-RSs 2001 would be associated with a different beam sequence ID which could be derived from each of the BQM-RSs 2001. For example, ID 0˜ID 3, are transmitted via four cell's scan beams steered to four different directions for cell 0 2002 and cell 1 2003, but each cell (0, 1) would transmit a different ID at any given time period. In response to receiving the BQM-RSs 2001, the UE would perform a beam quality measurement and transmit the result of the beam quality measurement by using the best UE beam which in this example has been determined by the UE to be UE beam 1 2004.

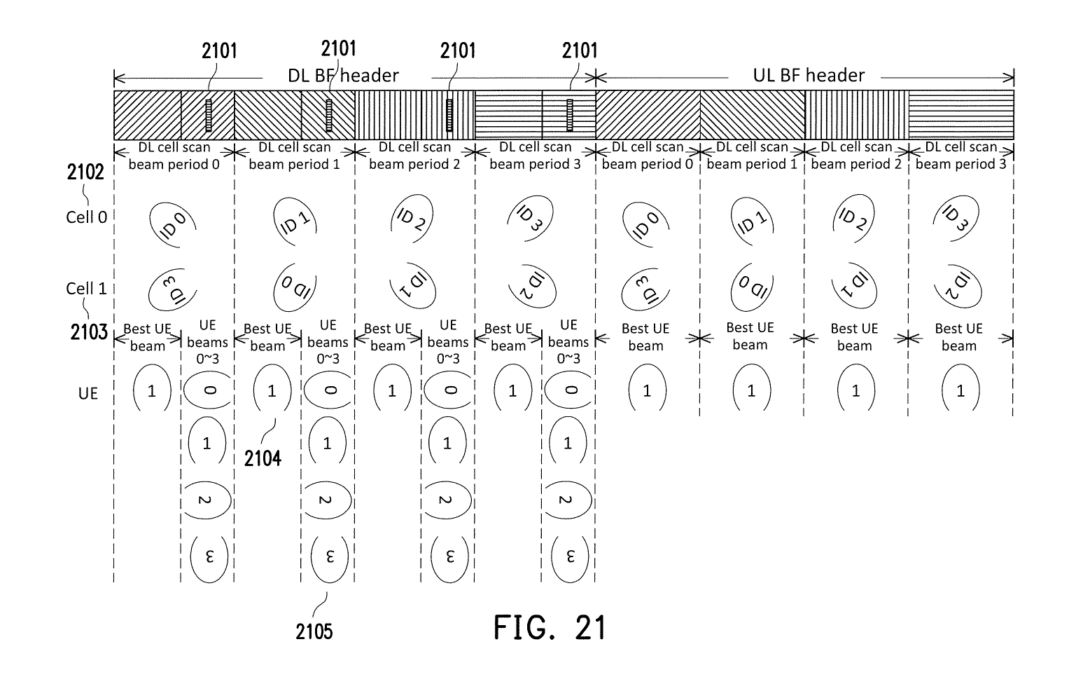

An example of distributed BTS based BQM-RSs for N_{d}=2, J=Q=4, and P=4 is shown in FIG. 21. The frame structure of this example would include at least but not limited to a DL BF header and a UL BF header. The DL BF header would include not limited to four DL scan beam periods, DL scan beam period 0, DL scan beam period 1, DL scan beam period 2, and DL scan beam period 3. Each of the four BQM-RSs 2101 would be associated with a different beam sequence ID. For example ID 0˜ID 3, are transmitted via four different scan beams steered to four different directions for both cell 0 2102 and cell 1 2103. However, in this example, within each DL scan beam period, the UE may alternate between transmitting via the best UE beam 2104 and a full scan by using all four UE beams 2105. From the example of FIG. 20 and FIG. 21, it can be seen that the time for the measurements of all combinations of cells' scan beams and UE's scan beams is 4 mmWave time units for BSS based BQM-RSs and 1 mmWave time unit for BTS based BQM-RSs.

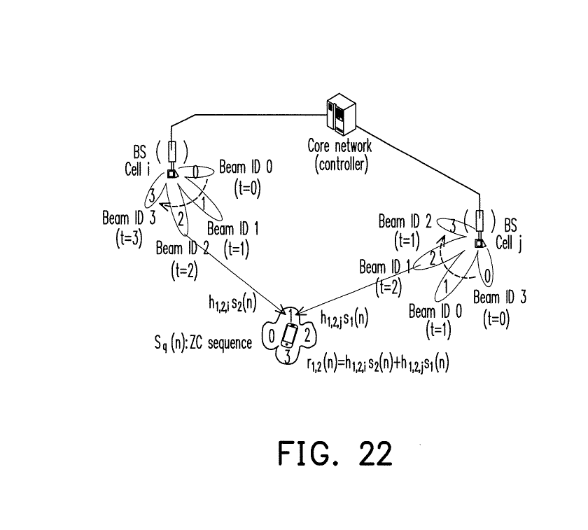

An example of how beam tracking could be conducted is shown in FIG. 22. In response to the UE receiving a plurality of BQM-RSs such as the BQM-RSs from the cell beam which corresponds to ID 2 from cell i and the cell beam which corresponds to ID 1 from cell j, the UE would measure the beams' signal-to-noise ratio (SNR) and record such information in a SNR list or table which could be stored and updated in a storage medium of the UE. Based on the measurements of the BQM-RSs, the UE may be able to determine its preferred beam and cell's preferred beam.

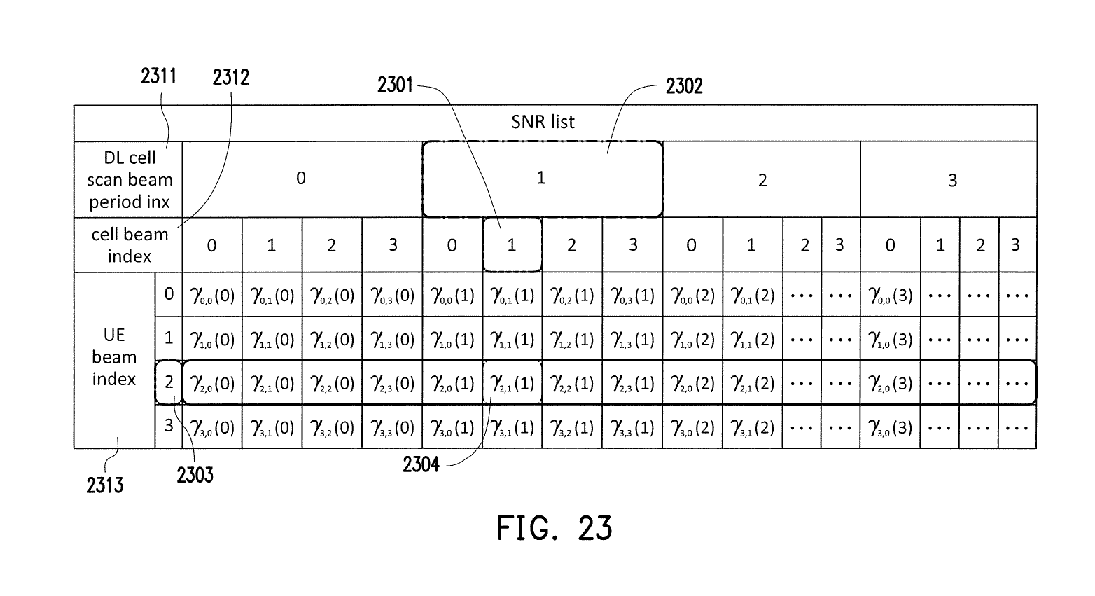

The above described SNR table is shown in FIG. 23. Although the beam tracking could be done by performing beam's SNR measurement on the BQM-RSs at UE, other measurement standards could also be utilized such as signal-to-interference ratio (SIR), signal-to-interference-plus-noise ratio (SINR), received signal strength indicator (RSSI), reference signal received power (RSRP), reference signal received quality (RSRQ), and so forth. The SNR table for each of combinations of cell's beams and UE's beams could be calculated based on the time domain matched-filter (MF) output SNR. The SNR table may include a cell beam index for each DL cell scan beam period 2311, an index for beams in a cell 2312, and an index of UE's scan beams 2313. The contents of the SNR table could be transmitted in part or in whole from the UE to a BS as a measurement report which may include an index of a preferred cell beam and at least two beam quality measurements. As the UE has received cell scan beams from various cells, the UE would perform measurements to fill up or update the table and determine a preferred UE beam index based on the maximum SNR value (e.g. 2304) or other metrics measured. From the SNR table, the UE may report to one or more BSs including one or more of the following list not limited to: the index of a preferred cell's beam (e.g. 2301) and the index of a preferred DL cell scan beam period (e.g. 2302), or a small subset of the row of the preferred UE beam index. It is worth noting that only the information of the beam's quality but not the cell's quality could be obtained in beam tracking. The total (fixed number) J²P SNRs in the SNR table may need to be calculated as shown in FIG. 23. It may higher computational complexity but no extra signaling or including configurations could be needed by the network.

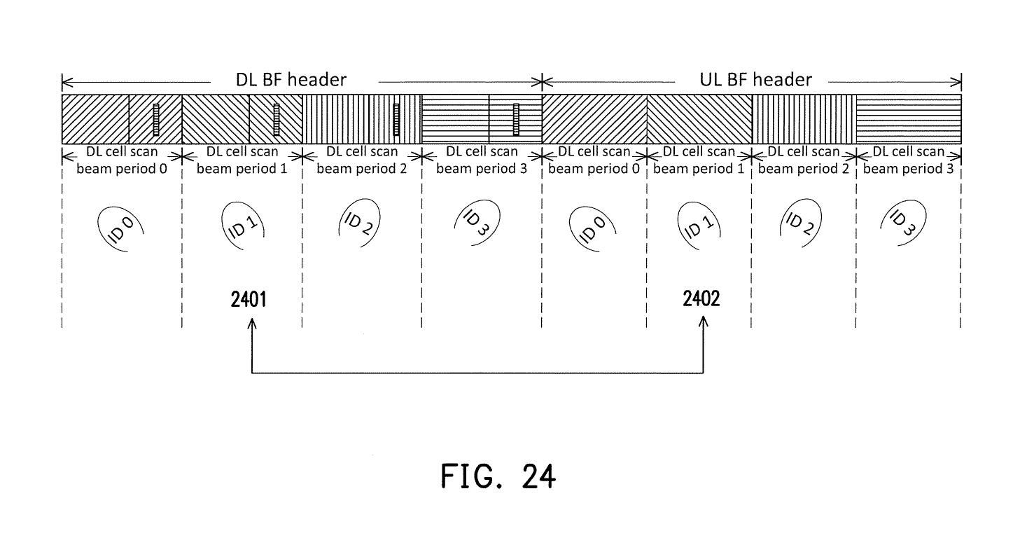

An exemplary embodiment of the timing of SNR measurement reporting is shown in FIG. 24. For this exemplary embodiment, the BSs or the controller would simply receive, from a UE scan beam, a measurement report without requiring to know which of the UE scan beams is the preferred or the best UE beam as such decision is made by the UE. The measurement report containing SNRs (or other signal quality measurement metrics) could be reported at a preferred report time in UL decided by UE. The measurement report could be transmitted by using a preferred UE's beam or by using a current UE beam, and the measurement report could be received from a preferred cell beam or a current cell beam. For example, after the maximum SNR and the preferred UE beam has been determined based on the DL cell scan beam received during DL cell scan beam period 1 2401, the UE would need to transmit the measurement report at the preferred report time during UL cell scan beam period 1 2402. Such relationship could defined by the TDM based beam sequence ID mapping table of FIG. 12. During the preferred report time, information from the SNR table and the preferred beam sequence ID which corresponds to the cell scan beam could be reported by the UE to the one or more BSs. The SNR or preferred beam sequence ID corresponding to the cell scan beam could be reported on physical uplink control channel/physical uplink shared channel (PUCCH/PUSCH) of a BF header by using preferred UE's scan beam. The preferred report time could be the current use report time or the UL time corresponding to the time used by the cell's receive scan beam having the maximum measurement SNR in DL as shown in FIG. 24.

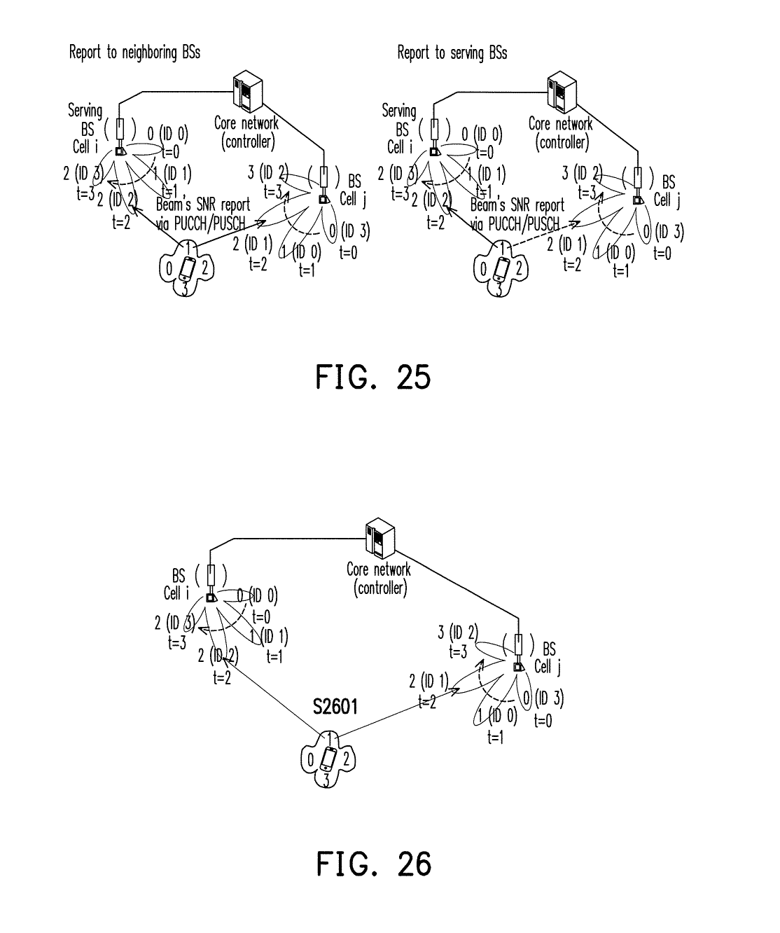

FIG. 25 shows such example of SNR reporting from a UE to BSs within a multi-cell group of an mmWave capable communication network. The preferred time or predetermined period could be decided by a UE. The cell beam's SNR measurement report would be transmitted by the UE to the serving BS and/or to the neighboring BSs at the preferred or predetermined period by using the preferred UE's and cell's scan beams as determined by the UE. The preferred UE's scan beam could be the current use UE's beam or the UE's beam having the maximum measurement SNR in an SNR table. Then a preferred cell could be decided by the controller based on the received quality of the report in PUCCH/PUSCH reported by the UE.

The random access preamble used by a UE could be known by some BSs or the controller that are near the UE. FIG. 26 shows an example of RAP transmission by a UE. The UE may transmit the RAP (e.g. S2601) via a random access channel (RACH). The RAP could be transmitted on RACH of a BF header by using a preferred UE scan beam which could be a currently used UE scan beam or could be a UE scan beam having the maximum SNR in the SNR table. The RAP could be received by cell scan beams from multiple cells with a preferred or predetermined period.

When a cell has received PUCCH RS/PUSCH RS and/or RACH from an UL signal of a UE, the cell may perform the SNR measurement based on the received PUCCH RS/PUSCH RS and/or RAP. The SNR measurement on the received PUCCH RS/PUSCH RS and/or RAP for each of cells could be done by multiple BSs, in an uplink (UL) portion of a beamforming (BF) header during a preferred time period defined by the above described mapping table. The cell's SNR measurements at BSs could be transmitted to a controller which would then determine one or more preferred cells to serve the UE by comparing the cell's SNR measurements at BSs. The BSs may also maintain a cells' SNR table to perform such comparison.

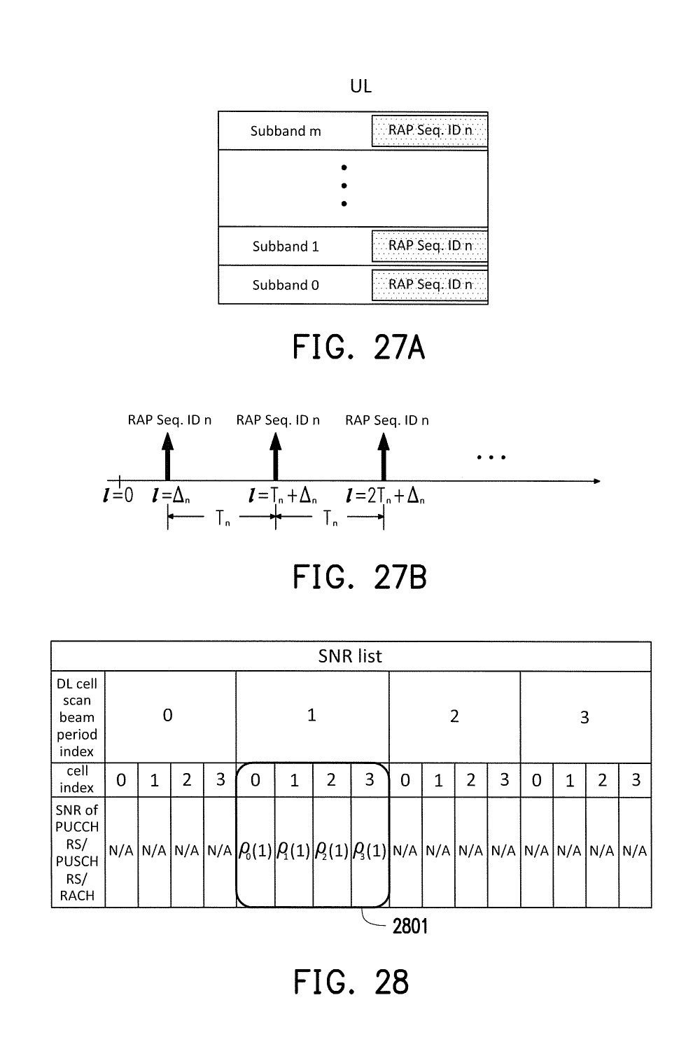

The above described RAP would be a non-contention based RAP. To enhance the diversity of non-contention based RAP, subband based allocations in frequency domain is shown in FIG. 27A and periodicity based transmission in time domain could be considered and is shown in FIG. 27B. According to an exemplary embodiment, a shorter transmission period of RAP could be used for higher mobility UEs, and a longer transmission period of RAP could be used for lower mobility UEs.

FIG. 28 illustrates a cells' SNR table in accordance with one of the exemplary embodiments of the disclosure. According to an exemplary embodiment, a total N_{d} SNRs, which is a fixed number, may need to be calculated. The cells' SNRs could be known only to the BSs and the controller by cell's SNR measurement itself on PUCCH RS/PUSCH RS and/or RAP. For example, as shown in 2801 of FIG. 28, during DL cell scan beam period index 1, for each of the cells corresponds to index 0, 1, 2, and 3, the SNR of PUCCH RS, RUSCH RS or RAP of the corresponding cell would be calculated ad entered in the table for recording and comparison purposes.

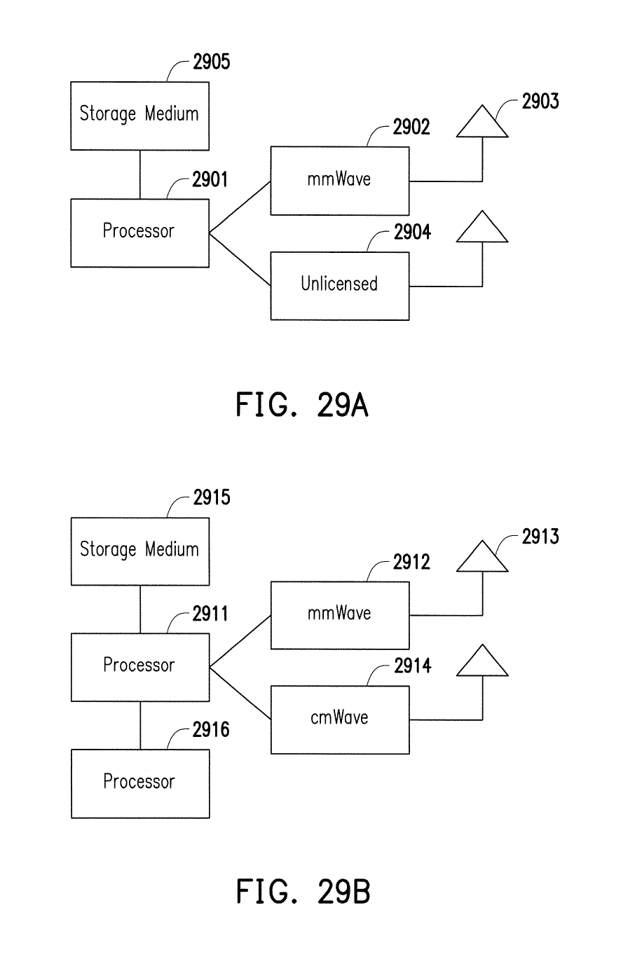

FIG. 29A is a functional block diagram of a UE in accordance with one of the exemplary embodiments of the disclosure. The UE may include not limited to a processor 2901 coupled to a storage medium 2905, a mmWave 2902 transceiver, an unlicensed band transceiver 2904, and an antenna array 2903. The storage medium 2905 provides temporary storage or permanent storage such as the SNR table of FIG. 23, the TDM mapping table of FIG. 12, and other related data. The mmWave 2902 transceiver includes one or more transmitters and receivers connected to the antenna array 2903 to transmit beamformed signals. The unlicensed band transceiver 2904 may include one or more transceivers for communicating in the unlicensed spectrum such as Wi-Fi, Bluetooth, NFC, and etc. The processor 2901 may include one or more hardware processing units such as processors, controllers, or discrete integrated circuits to control the mmWave 2902 transceiver to transmit and receive beamformed signals and to execute functions related to the above described beam tracking method and its related exemplary embodiments and examples.

The term “user equipment” (UE) in this disclosure may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and the like. In some applications, a UE may be a fixed computer device operating in a mobile environment, such as a bus, a train, an airplane, a boat, a car, and so forth.

FIG. 29B is a functional block diagram of a BS in accordance with one of the exemplary embodiments of the disclosure. The BS may include not limited to a processor 2911 coupled to a storage medium 2915, a mmWave 2912 transceiver, an CM wave transceiver 2914, and an antenna array 2913. The storage medium 2915 provides temporary storage or permanent storage such as the SNR table of FIG. 23, the TDM mapping table of FIG. 12, and other related data. The mmWave 2912 transceiver includes one or more transmitters and receivers connected to the antenna array 2913 to transmit beamformed signals. The processor 2911 may include one or more hardware processing units such as processors, controllers, or discrete integrated circuits to control the mmWave 2912 transceiver to transmit and receive beamformed signals and to execute functions related to the above described beam tracking method and its related exemplary embodiments and examples.

The term BS in this disclosure could be a variation or a variation or an advanced version of a macro cell BS, micro cell BS, pico cell BS, femto cell BS, “eNodeB” (eNB), a Node-B, an advanced BS (ABS), a base transceiver system (BTS), an access point, a home BS, a relay station, a scatterer, a repeater, an intermediate node, an intermediary, satellite-based communication BSs, and so forth.

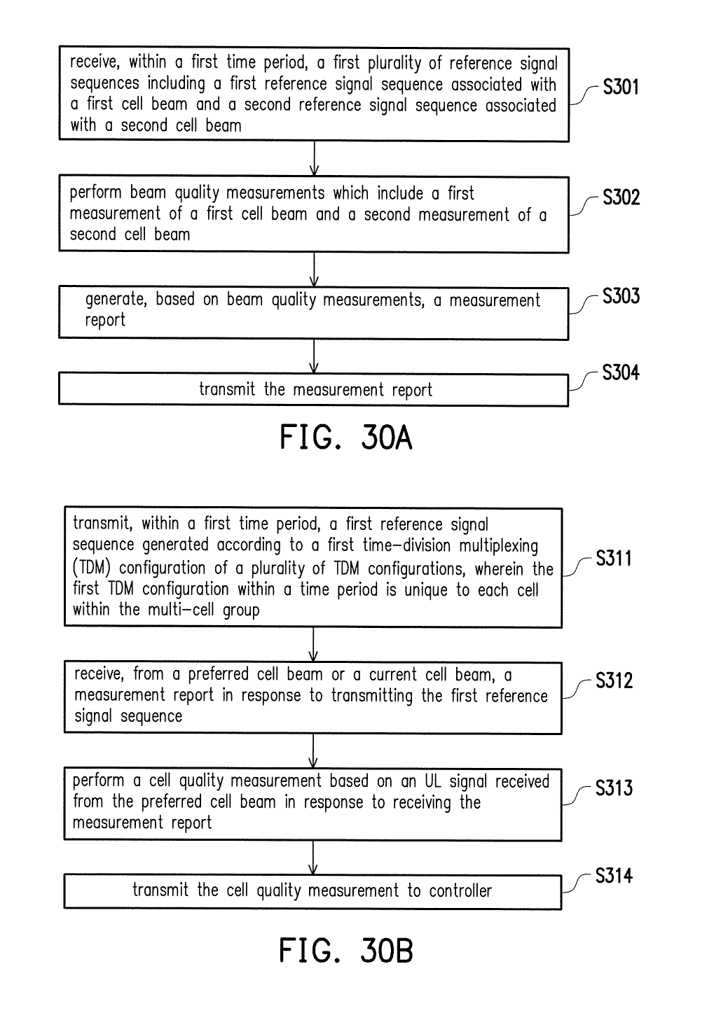

FIG. 30A illustrates steps of a beams tracking method used in a multi-cell group of a millimeter wave communication system from the perspective of a UE in accordance with one of the exemplary embodiments of the disclosure. In step S3001, the UE would receive, within a first time period, a first plurality of reference signal sequences including a first reference signal sequence associated with a first cell beam and a second reference signal sequence associated with a second cell beam. In step S3002, the UE would measure a beam quality which includes a first measurement of a first cell beam and a second measurement of a second cell beam. In step S3003, the UE would generate, based on the beam quality, a measurement report. In step S3004, the UE would transmit the measurement report.

FIG. 30B illustrates steps of a beams tracking method used in a multi-cell group of a millimeter wave communication system from the perspective of a BS in accordance with one of the exemplary embodiments of the disclosure. In step S3011, the BS would transmit, within a first time period, a first reference signal sequence generated according to a first time-division multiplexing (TDM) configuration of a plurality of TDM configurations, wherein the first TDM configuration within a time period is unique to each cell within the multi-cell group. In step S3012, the BS would receive, from a preferred cell beam or a current cell beam, a measurement report in response to transmitting the first reference signal sequence. In step S3013, the BS would perform a cell quality measurement based on the measurement report. In step S314, the BS would transmit the cell quality measurement to controller. Thus a change from the first TDM configuration to a second TDM configuration is determined by a controller.

In view of the aforementioned descriptions, the present disclosure is suitable for being used in a wireless communication system and is able to track beam qualities received by a UE as well as cell quality measured by a BS in a manner which may lessen computational complexity, reduce signaling overhead, and reduce required measurement period.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A beam tracking method used by a user equipment (UE) in a multi-cell group of a millimeter wave communication system, and the method comprising:
receiving, within a first time period, a first plurality of reference signal sequences comprising a first reference signal sequence associated with a first cell beam and a second reference signal sequence associated with a second cell beam;
measuring a beam quality which comprises a first measurement of a first cell beam and a second measurement of a second cell beam;
generating, based on the beam quality, a measurement report; and
transmitting the measurement report.

2. The method of claim 1, wherein the measurement report comprises an index of a preferred cell beam and at least two beam quality measurements.

3. The method of claim 2, wherein the index of the preferred cell beam corresponds to the first cell beam in response to the first cell beam having been determined to have a highest beam quality of cell beams among the beam quality measurements.

4. The method of claim 3, wherein transmitting the measurement report comprising:
transmitting the measurement report by using a preferred UE beam.

5. The method of claim 4, wherein the preferred UE beam corresponds to a currently in use UE beam or the highest beam quality of cell beams among the beam quality measurements.

6. The method of claim 1, wherein the first reference signal sequence is derived from a first beam quality measurement reference signal (BQM-RS) received from the first cell beam, and the second reference signal sequence is derived from a second beam quality measurement reference signal (BQM-RS) received from the second cell beam.

7. The method of claim 3, wherein determining the highest beam quality among the beam quality measurements comprising:
recording or updating each of the beam quality measurements; and
determining the highest beam quality of cell beams from the beam quality measurements based on one of the beam quality measurements having a highest signal to noise ratio (SNR) value.

8. The method of claim 7 further comprising:
maintaining the beam quality measurements in a table, wherein each of the beam quality measurements corresponds to a cell beam index and a UE beam index.

9. The method of claim 4, wherein transmitting the measurement report comprising:
transmitting the measurement report in a physical uplink control channel (PUCCH) or a physical uplink shared channel (PUSCH) in an uplink (UL) portion of a beamforming (BF) header during a preferred time period.

10. The method of claim 9 further comprising:
transmitting a random access preamble (RAP) in a physical random access channel (PRACH) during the preferred time period.

11. The method of claim 10, wherein the preferred time period corresponds to a currently in use UL time period or a UL time period associated with the cell beam having the highest beam quality of cell beams among the beam quality measurements in downlink (DL).

12. The method of claim 9, wherein the RAP is either frequency subband based or periodicity based.

13. A beam tracking method used by a base station (BS) in a multi-cell group of a millimeter wave communication system, and the method comprising:
transmitting, within a first time period, a first reference signal sequence generated according to a first time-division multiplexing (TDM) configuration of a plurality of TDM configurations, wherein the first TDM configuration within a time period is unique to each cell within the multi-cell group;
receiving, from a preferred cell beam, a measurement report in response to transmitting the first reference signal sequence;
performing a cell quality measurement based on an UL signal received from the preferred cell beam in response to receiving the measurement report; and
transmitting the cell quality measurement to controller.

14. The method of claim 13, wherein transmitting a first reference signal sequence comprising:
transmitting the first reference signal sequence which corresponds to a first beam sequence identifier (ID) of a plurality of beam sequence IDs based on the first time-division multiplexing (TDM) configuration of the plurality of TDM configurations.

15. The method of claim 14 further comprising:
transmitting, within the first time period, a second reference signal sequence corresponding to a second beam sequence ID of the plurality of beam sequence IDs, wherein the plurality of beam sequence IDs are shared by another base station of the multi-cell group.

16. The method of claim 13, wherein the measurement report comprises an index of a preferred cell beam and at least a part of the cell quality measurements.

17. The method of claim 16, wherein the preferred cell beam corresponds to a currently in use cell beam or a cell beam having been determined to have a highest beam quality among the beam quality measurements.

18. The method of claim 15, wherein the first beam sequence ID corresponds to a first beam quality measurement reference signal (BQM-RS) located in a first cell beam transmitted by the base station, and the second beam sequence ID corresponds to a second BQM-RS located in a second cell beam transmitted by the base station.

19. The method of claim 18, wherein receiving the UL signals from the preferred cell beam comprising:
receiving a signal quality measurement of the first BQM-RS in the measurement report, wherein the measurement report is located in a physical uplink control channel (PUCCH) or a physical uplink shared channel (PUSCH) in an uplink (UL) portion of a beamforming (BF) header during a preferred time period.

20. The method of claim 19, wherein receiving the UL signals from the preferred cell beam comprising:
receiving a random access preamble (RAP), wherein the RAP is located in a physical random access channel (PRACH) in an uplink (UL) portion of a beamforming (BF) header during a preferred time period.

21. The method of claim 20, wherein the preferred time period corresponds to a currently in use UL time period or a UL time period associated with the cell beam having the highest beam quality of cell beams among the beam quality measurements in downlink (DL).

22. The method of claim 13, wherein performing the cell quality measurement based on the received UL signals comprising:
performing the cell quality measurement on a PUCCH or a PUSCH or a PRACH or reference signals associated with the PUCCH or PUSCH of the preferred cell beam during a preferred time period.

23. The method of claim 22, wherein the RAP is either frequency subband based or periodicity based.

24. The method of claim 13, wherein the first TDM configuration of the plurality of TDM configurations is configured or semi-persistently scheduled or dynamically scheduled by a controller and a change from the first TDM configuration to a second TDM configuration is determined by a controller.

25. The method of claim 13, wherein the preferred cell beam is determined based on the measurement report which is received on the cell beams from UE.

26. The method of claim 13, further comprising:
receiving a decision of a preferred cell from the controller based on the cell quality measurements on the UL signal received from the preferred cell beam.

27. A user equipment comprising:
a transmitter;
a receiver; and
a processor coupled to the transmitter and the receiver and configured to:
receive, via the receiver within a first time period, a first plurality of reference signal sequences comprising a first reference signal sequence associated with a first cell beam and a second reference signal sequence associated with a second cell beam;
measuring a beam quality which comprise a first measurement of a first cell beam and a second measurement of a second cell beam;
generating, based on the beam quality, a measurement report; and
transmit, via the transmitter, the measurement report.

28. A base station comprising:
a transmitter;
a receiver; and
a processor coupled to the transmitter and the receiver and configured to:
transmit, via the transmitter within a first time period, a first reference signal sequence generated according to a first time-division multiplexing (TDM) configuration of a plurality of TDM configurations, wherein the first TDM configuration within a time period is unique to each cell within a multi-cell group;
receive, via the receiver from a preferred cell beam, a measurement report in response to transmitting the first reference signal sequence;
perform a cell quality measurement based on an UL signal received from the preferred cell beam in response to receiving the measurement report; and
transmit, via the transmitter, the cell quality measurement to controller.
